(19) United States
(12) Patent Application Publication
(10) Pub. No.: US 2026/0172360 A1
(43) Pub. Date: Jun. 18, 2026

(54) METHOD AND APPARATUS TO BATCH PACKET FRAGMENTS PRIOR TO ENTRANCE INTO A PROCESSING CORE QUEUE

(71) Applicant: Intel Corporation, Santa Clara, CA (US)

(72) Inventors: Joy DEVASSYKUTTY PULLOKARAN, Bangalore (IN); Zhijun TANG, Beijing (CN); Ravikumar AIMANGALA NAGARAJA SETTY, Bangalore (IN); Deepak KHANDELWAL, Bangalore (IN); Rajakumar CHIDAMBARAM, Bangalore (IN); Joseph Maria Jaison VINCENT SOLOMON, Bangalore (IN); Balaji CHINTALAPALLE, Bengaluru (IN); Satya Venkata Naga Harish KODURI, Bengaluru (IN); Abhinandan GUJJAR, Bangalore (IN); Yiming JING, Shanghai (CN); Xiao WANG, Shanghai (CN); Dong WANG, Beijing (CN); Pan ZHANG, Beijing (CN); Junfeng GUO, Shanghai (CN)

(21) Appl. No.: 19/125,045

(22) PCT Filed: Dec. 5, 2022
(86) PCT No.: PCT/CN2022/136666

§ 371 Date: Apr. 28, 2025

(51) Int. Cl. H04L 47/125; H04L 47/62

(52) U.S. Cl. CPC H04L 47/125; H04L 47/621

(57) ABSTRACT

An apparatus is described. An apparatus includes first circuitry to determine a particular processing core amongst a plurality of processing cores for an IP fragment based at least in part on the IP fragment's IP fragmentation ID. The apparatus includes second circuitry to enqueue the IP fragment for the particular processing core.

### BACKGROUND

High performance data centers rely on high performance networking infrastructure to efficiently stream packets to/from the data center's respective computing systems. The networking infrastructure is therefore expected to handle the different kinds of packet streams that could flow to and/or from these computing systems.

### BRIEF DESCRIPTION OF DRAWINGS

FIG. 1 shows an electronic system;

FIG. 2 shows fragmentation of a packet;

FIGS. 3a, 3b, 3c and 3d pertain to a process for packing fragments of a packet;

FIG. 4 shows secondary fragmentation of a packet;

FIGS. 5a and 5b pertain to a process for packing fragments of a packet whose fragments have been fragmented twice;

FIG. 6 shows a system;

FIG. 7 shows a data center;

FIG. 8 shows a rack.

### DETAILED DESCRIPTION

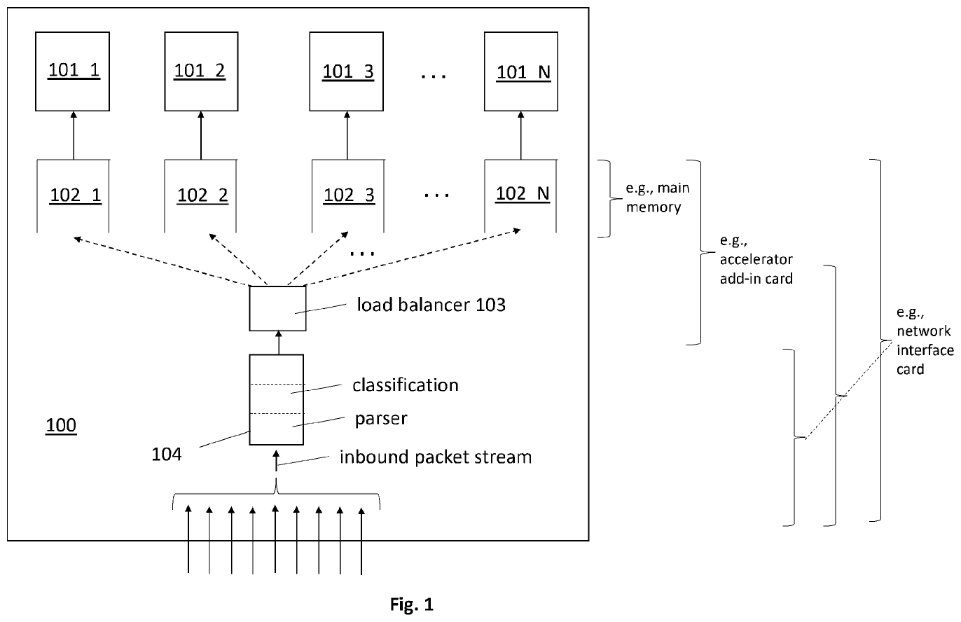

FIG. 1 shows a system 100 (e.g., a computer system, a network system) that transmits/receives packets to/from one or more networks. The system 100 includes a plurality of processing cores 101_1 through 101_N that process the packets it receives in any of a variety of ways. For example, the processing cores 101 can perform network address translation (NAT) for Internet Protocol (IP) related flows (IP address and/or port information is changed for IPV4 flows or IPv4 to IPv6 flows, etc.), security related functions (e.g., that snoop packet payload for harmful content), etc.

In the particular system 100 of FIG. 1, the processing cores 101_1 through 101_N are coupled to respective inbound queues 102_1 through 102_N. Here, when a received packet is placed in the inbound queue of a particular processing core, the packet (or portion thereof) is processed by the processing core.

The queues are preceded in the inbound direction by a load balancer 103, and, the load balancer is preceded by a packet processing pipeline 104. According to a traditional implementation, the load balancer 103 is another processing core and the packet processing pipeline is disposed on a network interface card (NIC) or other kind of, e.g., pluggable I/O network interface component.

In the inbound direction the packet processing pipeline 104 parses incoming packets and classifies them according to the content of their header information. Here, classification traditionally involves recognizing packets with a same tuple of source IP address, destination IP address and protocol field in their respective headers as belonging to a same “flow”. That is, packets having the same above described tuple information are recognized as being different components of a singular stream of information that is flowing from a network into the system. The classification process can entail assigning a unique flow ID to packets belonging to a same flow as meta data, and/or, capturing the three tuple as meta data.

The load balancer 103 attempts to evenly distribute the work performed by the processing cores 101_1 through 101_N on the incoming packets by evenly distributing the flows coming into the system across the queues 102_1 through 102_N. Here, the load balancer 103 assigns a specific flow to a specific queue. As the load balancer 103 receives the particular flow ID or three tuple of an incoming packet, e.g., as passed to the load balancer 103 from the packet processing pipeline 104, the load balancer 103 forwards the packet to the queue assigned to that packet's flow.

According to various system designs, the processing cores 101_1 through 101_N are general purpose processing cores that execute software programs designed to perform the various packet processing operations that the system 100 is expected to perform. As such, the queues 102_1 through 102_N are implemented as data structures in the main memory of the system 100 that the processing cores execute their software out of.

Here, the load balancer 103 can be another general purpose processing core that executes load balancing software. In this case, the load balancer 103 can have an associated queue (e.g., in main memory) to receive packets after they have been processed by the packet processing pipeline 104. The packets are dequeued from the load balancer's queue and entered into their appropriate, respective processor queues 102_1 through 102_N.

In an alternate approach the load balancing function 103 is integrated into the packet processing pipeline 104 (e.g., as a later stage of the pipeline 104) or otherwise onto a network interface component such as a network interface card (NIC) (a network interface component includes a host interface to plug into a larger host/computer system, a network interface to connect to a network and logic circuitry in between to process packets between the network and the host).

Thus, in this case, the load balancer 103 can be implemented, e.g., with dedicated hardwired logic circuitry and/or field programmable gate array (FPGA) logic circuitry like the other stages of the pipeline 104 or NIC hardware. The queues 102_1 through 102_N can still be implemented, e.g., as data structures in main memory (e.g., packets are forwarded from the packet processing pipeline 104 on a NIC to their appropriate queue locations in main memory), or, e.g., on a NIC.

In yet another approach the queues 102 and load balancer 103 are implemented as special acceleration hardware. For example, the queues 102 are implemented as memory chips on a peripheral component interconnect (PCIe) card that is plugged into the system. The PCIe accelerator card includes a high performance logic chip that, depending on accelerator design and/or configuration can perform load balancing functions (in which case the load balancer 103 is integrated on the accelerator card), store and forwarding functions (e.g., if the load balancing function is integrated on the packet processing pipeline 104) and/or other functions that are consistent with the queuing of packets received from the packet processing pipeline 104.

A problem can arise in the case of fragmented packets. Here, an originally created (larger) packet can be broken down into smaller packet fragments because the size of the original packet exceeds the maximum transmission unit (MTU) size of a network node that receives the packet.

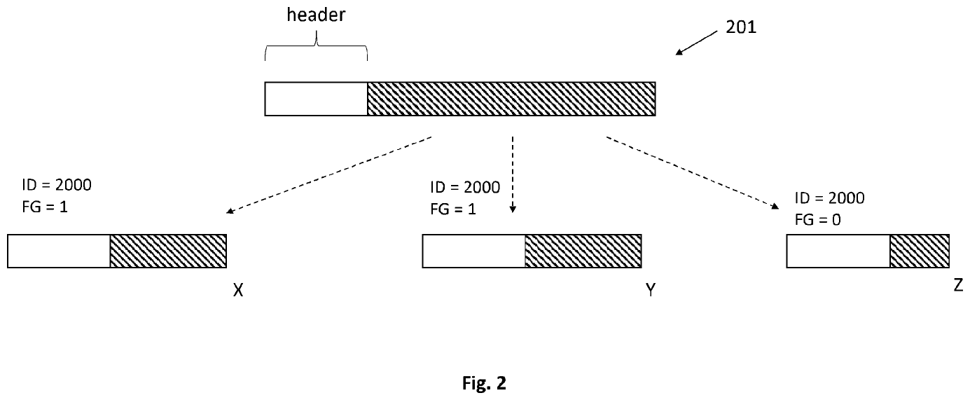

As observed in FIG. 2, a larger packet 201 is broken down into, e.g., three smaller fragments X, Y, Z. As part of the fragmentation process, the header information of the three smaller packets X, Y, Z includes the content from the larger packet but is further added with a fragmentation identification value (ID) and a fragmentation flag (FG). The fragmentation value uniquely identifies the segments created from a same, larger packet while the fragmentation flag provides an indication of how many fragments have been created. Here, as observed in FIG. 2, each of the fragments include a same identification value (2000). The first two fragments have their fragmentation flag set (indicating there exists another following segment) while the last fragment does not have its flag set (because it is the last of the fragments).

The added fragmentation information in the headers of each of fragments X, Y, Z also includes an offset value that identifies the byte count location within the original payload that marks a boundary of the fragment's payload. For ease of illustration the offset value is not depict. If a system that receives the three fragments X, Y, Z chooses to reassemble them to form the original packet 201, the offset and the flag information is processed by the receiving system to determine how many fragments were created from the original packet 201.

Referring back to the system of FIG. 1, if the system receives fragments X, Y, Z and is expected to perform some operation on the original packet 201, with one of its processing cores 101, the system 101 will need to reassemble the fragments X, Y, Z into the original packet 201 before the operation can be performed.

Although packet fragments X, Y, Z are apt to be sent to a same processor queue because they will have a same flow ID (same three tuple of source IP address, destination IP address and protocol), the processor is apt to receive the different fragments X, Y, Z at different moments in time. As such, upon a first of the fragments being entered into the processor's queue, the processor arranges buffering space in memory or cache for the different segments until all segments of the original packet have been received. The buffering allocation can be inefficient in terms of time and memory space as chunks of processor memory are specially allocated for the segments for as long as it takes all segments of the packet to arrive at the processor.

A solution is to introduce “reassembly flow” classification and “batching” of segments prior to the processor queues (e.g., the load balancer, the packet processing pipeline, etc.). Here, a reassembly flow is defined to include, according to various implementations, the IP fragmentation ID value found in a packet's header along with the three tuple that nominally define a flow (source IP address, destination IP address and protocol). Packet fragments having the same three tuple and IP fragmentation ID value are understood to be different fragments of a same larger packet and, importantly, are arranged together (“batched” or “packed”) as consecutive packets in the flow that the fragments belong to.

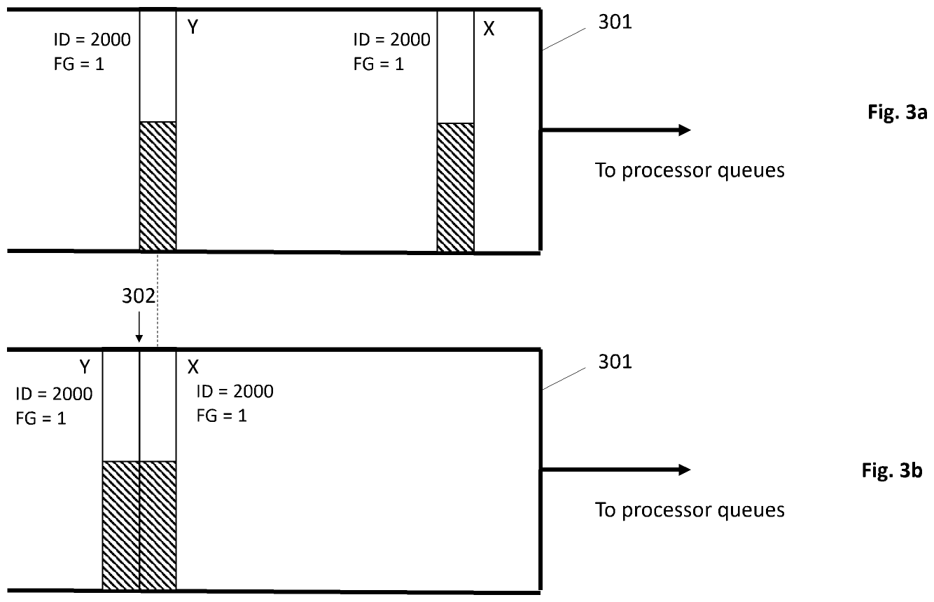

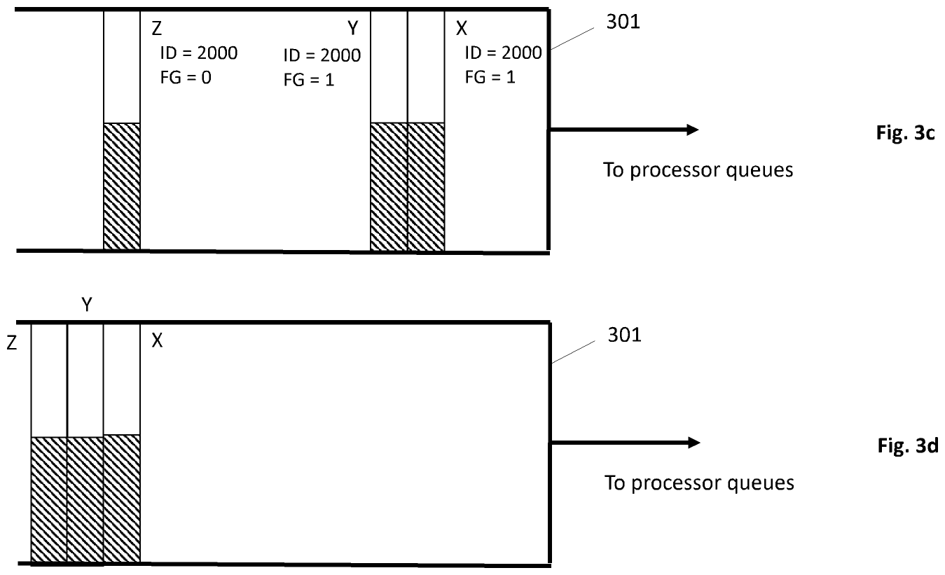

FIG. 3a shows an exemplary process in which two of the packet fragments X and Y are enqueued at the load balancer as an initial state. Here, for example, queue 301 is a queue that is associated with the load balancer (e.g., is implemented in main memory if the load balancer is a processing core, is implemented on an accelerator card if the load balancer is implemented on an accelerator card, etc.). Over the runtime of the system, for instance, the packet processing pipeline continuously forwards a next group of N packets to the queue 301. For ease of drawing FIG. 3a does not show the other packets in the queue 301 that precede fragment X and are in between fragments X and Y.

With reassembly flow definition, the load balancer recognize that the fragments X and Y belong to a same reassembly flow because they have same source IP address, destination IP address, protocol header value and fragmentation ID value (2000).

As such, as observed in FIG. 3b, the load balancer “batches” or “packs” the fragments having the same reassembly flow together in the queue. In the particular approach of FIG. 3b, the batch of fragments is placed at the location 302 of the last of the batched fragments in the queue (e.g., fragment X is placed ahead of fragment Y at fragment Y's location).

FIG. 3c shows the load balancer queue after some time has elapsed from the state in FIG. 3 b. Over the time from FIG. 3 b to FIG. 3 c the previously batched fragments X, Y have advanced forward in the queue 301 as the packets that preceded the batched fragments X, Y in the queue were forwarded to their respective processor queues. Moreover, additional packet transfer(s) were entered into the queue which included another fragment Z that is a sibling to the batched fragments X, Y. The load balancer is able to identify that recently arrived fragment Z is a fragment sibling of batched fragments X, Y because it has the same tuple and fragmentation ID value (2000) as the batched fragments.

As such, as observed in FIG. 3d, the load balancer batches the fragments again with all three fragments being batched together in the queue at the location of the most recently received fragment. From their flag and offset information, the load balancer is able to determine that the batch X, Y, Z of fragments is the complete set of fragments needed to fully reassemble the original packet. As such, the fragments will progress through the queue together and then be allowed to transfer to their (same) processor queue in order. The associated processor will have to expend little, if any, buffering time or memory space on account of all segments needed to construct the complete packet being received in the processor's queue in direct succession.

In cases where a partial batch of fragments (e.g., X and Y in FIG. 3c) reaches the head of the queue 301 before one or more of the remaining fragments (fragment Z) is entered in the queue 301 the load balancer can either refrain from transferring the partial batch to their processor queue (e.g., locally cache the partial batch near the queue 301), or, allow the partial batch to transfer to their processor queue. The former approach integrates more functionality and storage/memory space needs at the load balancer but yields minimal processor inefficiency when reassembling the original packet (in various embodiments, lead fragments toward the head of the queue 301 can only be delayed for a limited period of time, e.g., as set by a timer). By contrast, the later approach simplifies the logic and storage/memory needs of the load balancer but there can be circumstances where the processor maintains inefficient buffering for a set of fragments, e.g., if a last fragment arrives a substantial time after its sibling fragments.

Reassembly flow classification and batching can also be performed prior to processor queue entry at a stage other than load balancing. For example, the network interface could include an egress queue that queues packets for subsequent transfer to a load balancer queue or the processor queues after the packet processing pipeline has finished processing them. A controller on the network interface could perform the reassembly flow classification and batching described above with respect to FIGS. 3a through 3d above but within the network interface's egress queue.

In still other implementations, both the network interface and the load balancer perform reassembly flow classification and batching. In this case, for example, the load balancer's queue might be much deeper (larger) than the egress queue on a NIC. The NIC is therefore able to batch fragments that arrive to the system in close proximity timewise to one another but is not able to batch fragments that arrive to the system with extended periods of time between them. The load balancer with its deeper queue, however, is able to further pack the partial batches it receives from the NIC with the straggling fragments that arrived to late for the NIC to pack them.

More recent systems perform load balancing in acceleration hardware (e.g., with a high performance logic chip on a queuing acceleration add-in card, or, toward the back end of a packet processing pipeline) using a hash based queue assignment process such as receive side scaling (RSS).

In the case of RSS, a hash is performed with a (e.g., Toeplitz) hash key and a packet's flow related header information (e.g., as identified by the above described three tuple for layer 3 flows, or the three tuple and source port and destination port information for layer 4 flows). The hashing operation generates a hash signature which can be used to identify a particular processor queue (explicitly or impliedly by correlating specific hash signature values to specific processor queues).

Here, hashes performed on packets belonging to a same flow will have same packet header information and therefore will generate same hash signatures. As such, packets belonging to a same flow will be placed into a same processor queue. By contrast, packets belonging to different flows (and therefore having different header information) will generate different hash signatures and will be placed in different processor queues. The hash key is designed to evenly spread hash signatures from packet header space across the different processing queues, thereby effecting load balancing.

At least with RSS queue assignment approaches, problems can arise in the case of secondary fragmentation with packets that have multiple IP header fields. Secondary fragmentation can occur, e.g., when the size of a packet fragment exceeds a node's MTU. In this case the fragment is broken down into smaller, secondary fragments. Multiple IP header fields can exist in a packet's header structure when a packet is transferred across multiple IP networks (e.g., the internet and a proprietary IP network, a physical network and a virtual network, etc.).

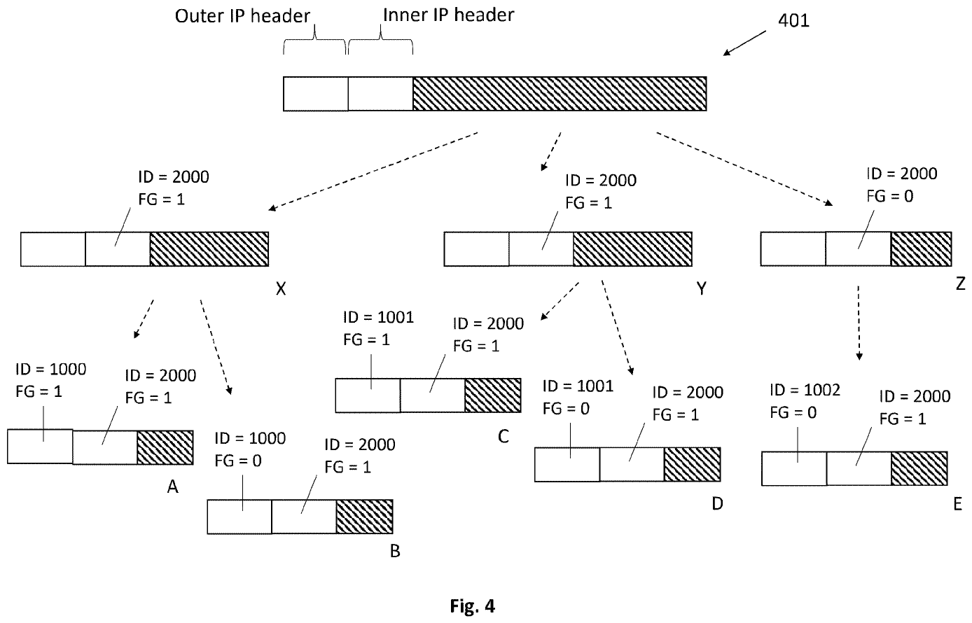

FIG. 4 shows another fragmentation example where the original packet 401 is expanded to include a second, outer IP header field. Here, for example, the packet 401 is to travel through a first IP network (which is represented by the “outer” IP header field) and then through a second IP network (which is represented by the “inner” IP header field).

Notably, the first level of fragmentation which creates first level fragments X, Y and Z modifies the “inner” IP header with identification and flag segmentation information (the outer IP header remains unchanged, which forces reassembly of the packet fragments at the second IP network). Because the first two first level segments X and Y are also too large, they are segmented to implement a second level of fragmentation for the packet 401 (secondary fragmentation).

FIG. 4 shows the fragmentation information in the respective secondary fragments A, B, C, D, E. Notably, the secondary fragmentation information is added to the outer IP header. Secondary fragments that originate from a same first level fragment are given their own unique fragmentation ID value.

As such, secondary fragments A and B have a same fragmentation ID value (1000) because they are fragments of fragment X, secondary fragments C and D have a same fragmentation ID value (1001) because they are fragments of fragment Y and secondary fragment E has its own fragmentation value (1002) because its payload content is a copy of fragment Z's. The flag information is also set to indicate that no more fragments exist for secondary fragments B, D and E.

Here, the fragmentation ID values added to the outer IP header of the secondary fragments A, B, C, D, E allows the secondary fragments to be combined to form the respective parent fragments X, Y, Z that they originate from. That is, the fragmentation ID value of 1000 in the outer IP address of secondary fragments A and B allows fragment X to be reconstructed, the fragmentation ID value of 1001 in the outer IP address of secondary fragments C and D allows fragment Y to be reconstructed, and, the fragmentation ID value of 1002 in the outer IP address of secondary fragment E allows fragment Z to be reconstructed.

A reassembly problem can occur if a system that is coupled to the first IP network desires to reconstruct the original packet 501 from the secondary fragments A, B, C, D, E. Notably, the combined inner and outer fragmentation ID and flag values across the secondary fragments A, B, C, D, E are all unique (to properly reconstruct the original packet from the five secondary fragments in order, each of the secondary fragments includes a unique combination of fragmentation information).

In a worst case scenario, if RSS is attempted by the packet processing pipeline and/or the load balancer, and the hashing incorporates the segmentation information, the hashing information is sufficiently different across the secondary fragments A, B, C, D, E to cause one or more of the secondary fragments to be assigned to a different queue than one or more of the other secondary fragments.

A first solution is to force the reassembly flow definition described above to include the inner fragmentation ID value but not the outer fragmentation ID value. In this case, the load balancer will batch segments having a same inner fragmentation ID value. Here, because all of the secondary segments A, B, C, D, E have the same inner fragmentation ID value, the load balancer will batch all five secondary segments A, B, C, D, E as a packed unit (assuming all five segments are observed in the load balancer's queue).

With batching based on the inner fragmentation ID value, the load balancer can further examine the flag information of the inner IP header and the fragmentation ID value and flag values of the outer IP header from each of the secondary fragments A, B, C, D, E to understand when all the secondary fragments have been received and batched.

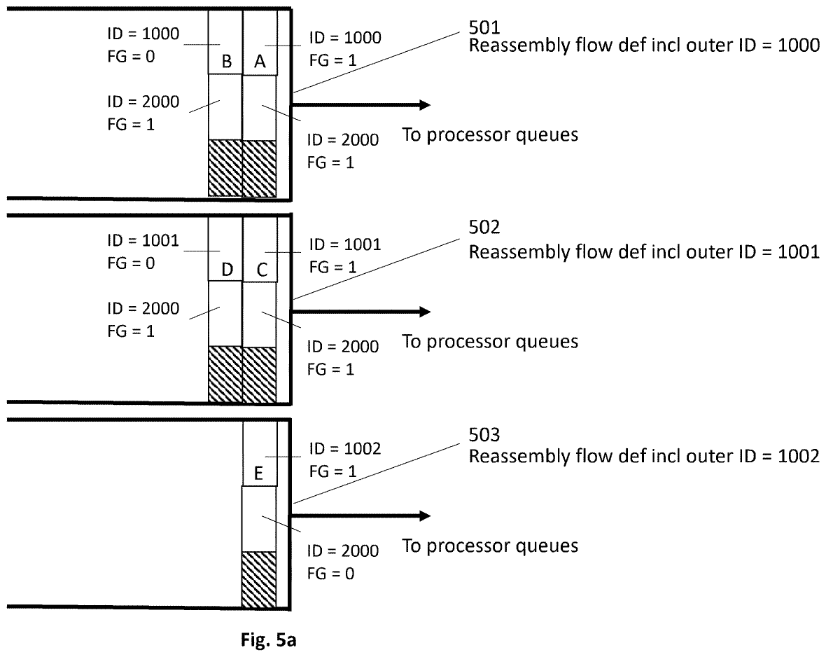

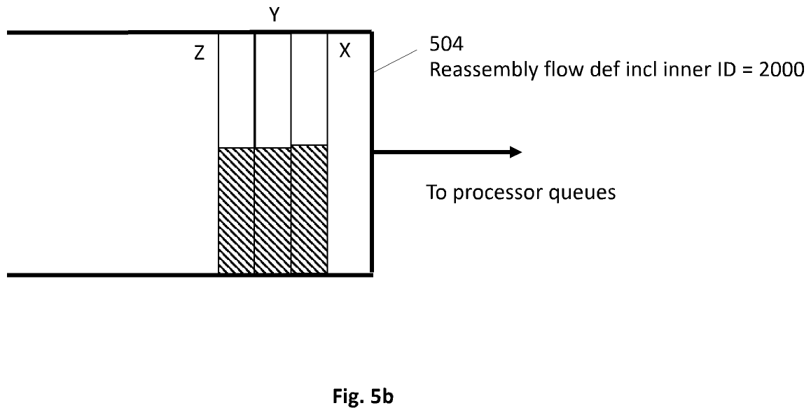

Another solution, observed in FIG. 5a and FIG. 5b, is to first define unique flows with dedicated queues based on the outer fragmentation ID value followed by a first level of reassembly that creates the first level fragments X, Y and Z. Another flow is then defined and another dedicated queue is created based on the inner fragmentation ID value followed by a second level of reassembly that creates the original packet 401.

Here the load balancer (again whether implemented as software executing on a processor core or with logic circuitry embedded on a queueing accelerator or in a packet processing pipeline stage) could be designed with enhanced functionality to implement, e.g., more queues than processors, assign multiple queues to a single processor and/or create separate, dedicated queues for individual flows (per flow queues).

In the case of the later (unique queues for unique flows), referring to FIG. 5a, separate reassembly flows are defined for the secondary fragments A, B, C, D, E based on the outer fragmentation ID value. As such, because there are three unique fragmentation ID values in the outer IP headers of the secondary fragments A, B, C, D, E, three separate reassembly flows will be defined and three corresponding queues 501, 502, 503 will be instantiated. That is, fragments A and B having same outer fragmentation ID value (1000) will be placed in queue 501, fragments C and D having same outer fragmentation ID value (1001) will be placed in queue 502 and fragment E having outer fragmentation ID value (1002) will be placed in queue 503.

The dedicated queues 501, 502, 503 effectively perform batching of the secondary fragments from which a same first level fragment was created. Thus, when both of secondary fragments A and B have been received and entered into queue 501 they are transferred as a batch to a processing core to which queue 501 is assigned. The assigned processing core then reassembles first level segment X from secondary fragments A and B. Similarly, when both of secondary fragments C and D have been received and entered into queue 502 they are transferred as a batch to a processing core to which queue 502 is assigned. The assigned processing core then reassembles first level segment Y from the secondary fragments C and D. Secondary fragment E has no siblings and can be immediately transferred to a processing core to which queue 503 is assigned (e.g., to perform any additional header processing beyond reassembly such as tunnel status removal).

According to one approach the queues 501, 502, 503 are assigned to different processing cores so that different processing cores can concurrently reassembly the secondary fragments into their respective first level fragments. In this case, each of the processors execute software that is designed to recognize that only a first level fragment has been created from the reassembly process or otherwise recognizes that a full packet has not yet been formed.

As such, the newly reassembled first level fragments X, Y and first level fragment Z are sent back to the load balancer by their respective processing cores. Upon the load balancer receiving a first of these, referring to FIG. 5b, the load balancer defines another reassembly flow ID based on the inner fragmentation ID value (2000) and another dedicated queue 504 is assigned to the newly defined flow.

As the other first level segments arrive at the load balancer they are entered in the dedicated queue 504 because of their common flow identification. When all of the first level fragments X, Y, Z have been entered in the queue 504 they are transferred as a batch to the processing core that has been assigned to the queue, which, in various embodiments, is the same processing core that is to perform some operation on the complete, full packet. The processing core then reassembles the complete packet from the first level fragments X, Y, Z and performs the operation.

Although embodiments above have emphasized the use of general purpose processing cores as the processing cores in the system, in various embodiments some other kind of processor could be used (e.g., dedicated logic cores that are designed to perform various operations on packet headers and/or payloads, infrastructure processing units (IPUs), security logic cores, etc.). Such processors could be implemented with dedicated networking logic circuitry (e.g., dedicated hardwired logic circuitry, FPGAs, etc.) or a combination of networking logic circuitry and logic circuitry designed to execute some form of program code.

Referring back to FIG. 1, the above described packet fragment reassembly improvements can be implemented in a data center environment where, e.g., the pipeline 103 is integrated on an infrastructure processing unit (IPU), orchestrator, or other function that has the networking intelligence to direct incoming packets with specific header information to, e.g., specific micro-service containers and/or instances.

Micro-services can be “pay per usage” services in which customers pay, e.g., for the execution of specific software function calls made to specific application software programs. This is believed to be a more efficient model than one in which customers pay for entire applications (e.g., that execute on a full time basis for the customer). In combination or in the alternative, micro-services can be a collection of fine-grained software functions (e.g., single task/function per call/invocation) that are individually/separably callable/invokable by a remote customer/client. Kubernetes or K8 is a popular platform for scaling out “containers” of micro-service execution environments.

Here, for instance, the processing cores 101 can execute the micro-services and the pipeline 503, e.g., is responsible for directing certain packet flows (reflecting certain clients) to certain processing cores (to implement certain micro-services for the clients). Thus, the processing cores 501 can be integrated in a same computing system as the pipeline 503, or, be integrated in one or more different computing systems where, e.g., a backbone network within the data center separates the cores 501 and the IPU having the pipeline 503.

The embodiments described above are believed to be workable with IPv4 and IPv6. Note also that if flows are defined based on an IP fragmentation ID value (which can additionally include the three tuple of IP source, IP destination and protocol ID), conceivably, hashes (such as Toeplitz RSS hashes) can be taken on the flow ID (rather than the three tuple and IP fragmentation ID) to properly assign packet fragments belonging to a same packet/flow to a same queue. The logic circuitry that is disposed, e.g., a NIC and/or load balancer add-in module, etc. to perform flow identification based on the IP fragment ID value and the subsequent enqueuing can be performed, with first circuitry that performs the IP fragmentation ID and second circuitry that performs the enqueuing by a processor that executes program code and/or dedicated logic circuitry.

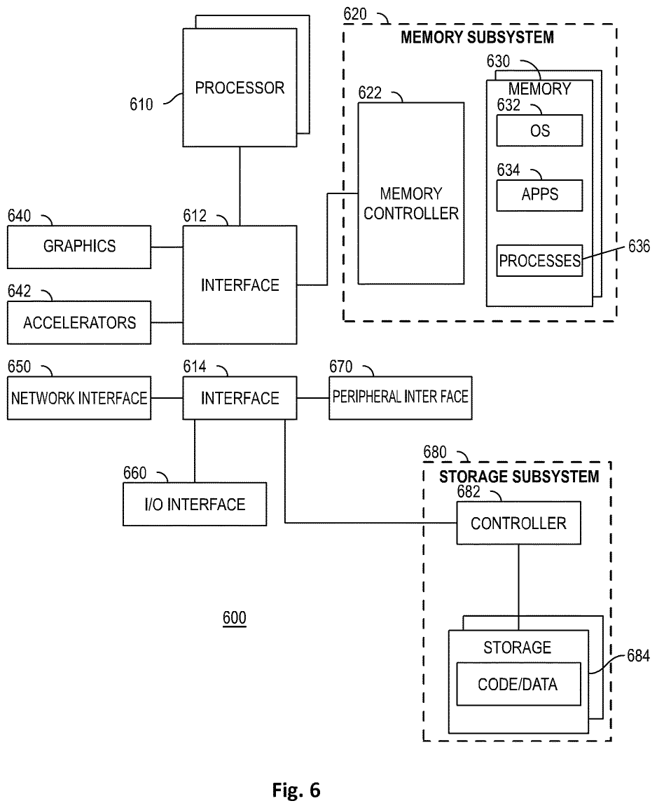

The following discussion concerning FIGS. 6, 7, and 8 are directed to systems, data centers and rack implementations, generally. FIG. 6 generally describes possible features of an electronic system that can include load balancing functionality as described at length above. FIG. 6 describes possible features of a data center that can include such electronic systems. FIG. 10 describes possible features of a rack having one or more such electronic systems.

FIG. 6 depicts an example system. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors to perform such networking functions (e.g., in a pipelined fashion or otherwise).

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 642, processor cores, or graphics processing units can be made available for use by artificial intelligence (AI) or machine learning (ML) models. For example, the AI model can use or include any or a combination of a reinforcement learning scheme, Q-learning scheme, deep-Q learning, or Asynchronous Advantage Actor-Critic (A3C), convolutional neural network, recurrent convolutional neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, volatile memory, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software functionality to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610. In some examples, a system on chip (SOC or SoC) combines into one SoC package one or more of: processors, graphics, memory, memory controller, and Input/Output (I/O) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on June 27, 2007). DDR4 (DDR version 4, initial specification published in September 2012 by JEDEC), DDR4E (DDR version 4), LPDDR3 (Low Power DDR version3, JESD 209-3B, August 2013 by JEDEC), LPDDR4 (LPDDR version 4, JESD 209-4, originally published by JEDEC in August 2014), WIO2 (Wide Input/Output version 2, JESD229-2 originally published by JEDEC in August 2014), HBM (High Bandwidth Memory), JESD235, originally published by JEDEC in October 2013, LPDDR 5, HBM 2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

The memory resources can also be tiered (different access times are attributed to different regions of memory), disaggregated (memory is a separate (e.g., rack pluggable) unit that is accessible to separate (e.g., rack pluggable) CPU units), and/or remote (e.g., memory is accessible over a network).

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits in both processor 610 and interface 614.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base, and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented as a disaggregated computing system. For example, the system 600 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 6, other types of systems to which the above described invention can be applied and are also partially or wholly described by FIG. 6 are communication systems such as routers, switches, and base stations.

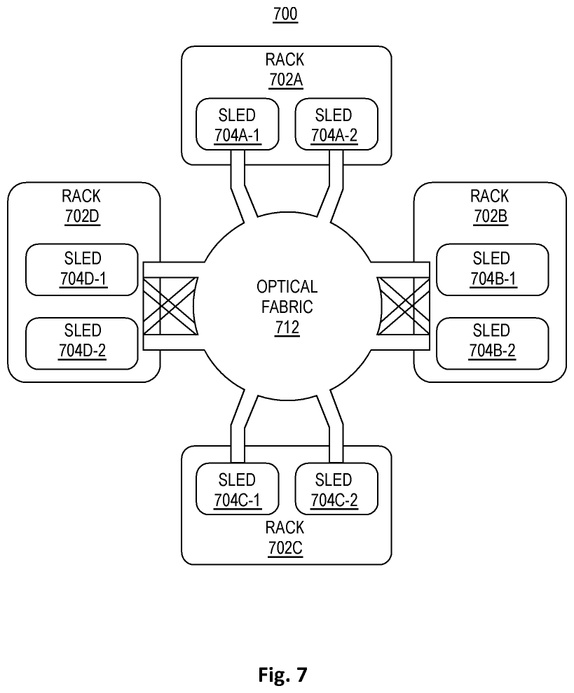

FIG. 7 depicts an example of a data center. Various embodiments can be used in or with the data center of FIG. 7. As shown in FIG. 7, data center 700 may include an optical fabric 712. Optical fabric 712 may generally include a combination of optical signaling media (such as optical cabling) and optical switching infrastructure via which any particular sled in data center 700 can send signals to (and receive signals from) the other sleds in data center 700. However, optical, wireless, and/or electrical signals can be transmitted using fabric 712. The signaling connectivity that optical fabric 712 provides to any given sled may include connectivity both to other sleds in a same rack and sleds in other racks.

Data center 700 includes four racks 702A to 702D and racks 702A to 702D house respective pairs of sleds 704A-1 and 704A-2, 704B-1 and 704B-2, 704C-1 and 704C-2, and 704D-1 and 704D-2. Thus, in this example, data center 700 includes a total of eight sleds. Optical fabric 712 can provide sled signaling connectivity with one or more of the seven other sleds. For example, via optical fabric 712, sled 704A-1 in rack 702A may possess signaling connectivity with sled 704A-2 in rack 702A, as well as the six other sleds 704B-1, 704B-2, 704C-1, 704C-2, 704D-1, and 704D-2 that are distributed among the other racks 702B, 702C, and 702D of data center 700. The embodiments are not limited to this example. For example, fabric 712 can provide optical and/or electrical signaling.

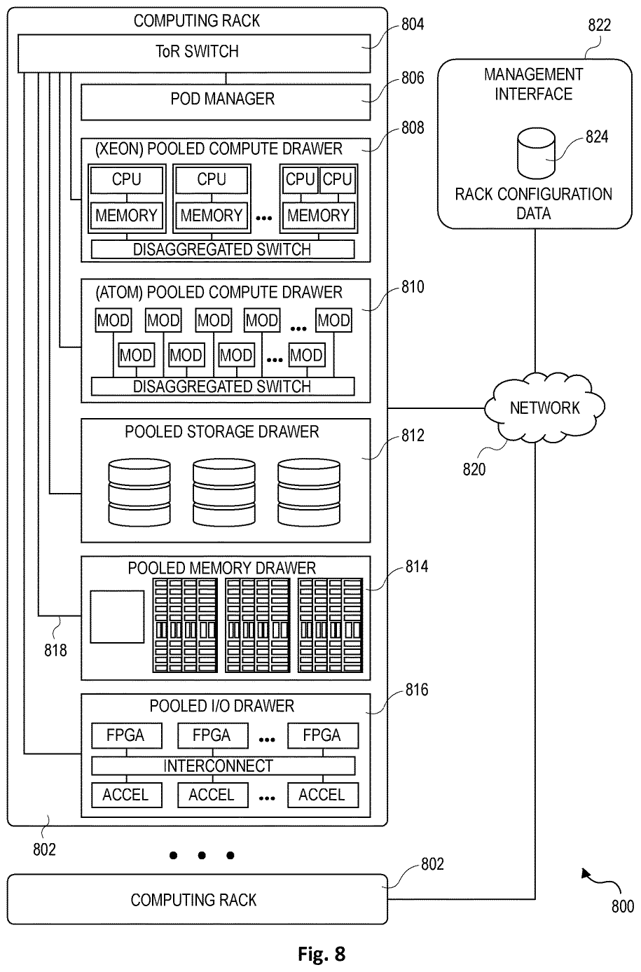

FIG. 8 depicts an environment 800 that includes multiple computing racks 802, each including a Top of Rack (ToR) switch 804, a pod manager 806, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 808, and INTEL® ATOM™ pooled compute drawer 810, a pooled storage drawer 812, a pooled memory drawer 814, and a pooled I/O drawer 816. Each of the pooled system drawers is connected to ToR switch 804 via a high-speed link 818, such as a 40 Gigabit/second (Gb/s) or 100 Gb/s Ethernet link or an 100+ Gb/s Silicon Photonics (SiPh) optical link. In one embodiment high-speed link 818 comprises an 600 Gb/s SiPh optical link.

Again, the drawers can be designed according to any specifications promul gated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 800 may be interconnected via their ToR switches 804 (e.g., to a pod-level switch or data center switch), as illustrated by connections to a network 820. In some embodiments, groups of computing racks 802 are managed as separate pods via pod manager(s) 806. In one embodiment, a single pod manager is used to manage all of the racks in the pod. Alternatively, distributed pod managers may be used for pod management operations. RSD environment 800 further includes a management interface 822 that is used to manage various aspects of the RSD environment. This includes managing rack configuration, with corresponding parameters stored as rack configuration data 824.

Any of the systems, data centers or racks discussed above, apart from being integrated in a typical data center, can also be implemented in other environments such as within a bay station, or other micro-data center, e.g., at the edge of a network.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled, and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software, and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1.-20. (canceled)

21. An apparatus, comprising:
first circuitry to determine a particular processing core amongst a plurality of processing cores for an Internet Protocol (IP) fragment based at least in part on the IP fragment's IP fragmentation ID; and,
second circuitry to enqueue the IP fragment for the particular processing core.

22. The apparatus of claim 21 wherein the first circuitry is to determine the particular processing core by performing a hash operation for the IP fragment.

23. The apparatus of claim 21 wherein the IP fragment is an IPv4 or IPv6 IP fragment.

24. The apparatus of claim 21 wherein the first circuitry is to determine the particular processing core based at least in part on the IP fragment's IP fragmentation ID, source address and destination address.

25. The apparatus of claim 21 wherein the IP fragmentation ID is a secondary IP fragmentation ID within an outer IP header of the IP fragment.

26. The apparatus of claim 21 wherein the second circuitry is to enqueue the IP fragment into a queue that is specially instantiated for a flow that is defined at least in part by the IP fragment's IP fragmentation ID.

27. The apparatus of claim 21 wherein the first circuitry and the second electronic circuitry are implemented as:
another one of the processing cores;
logic circuitry disposed on a queueing acceleration add-in module;
logic circuitry disposed in a stage of a packet processing pipeline.

28. A network interface component, comprising:
a host interface;
a network interface;
first circuitry to determine a particular processing core amongst a plurality of processing cores for an IP fragment based at least in part on the IP fragment's IP fragmentation ID; and,
second circuitry to enqueue the IP fragment for the particular processing core.

29. The network interface component of claim 28 wherein the first circuitry is to determine the particular processing core by performing a hash operation for the IP fragment.

30. The network interface component of claim 28 wherein the IP fragment is an IPv4 or IPv6 IP fragment.

31. The network interface component of claim 28 wherein the first circuitry is to determine the particular processing core based at least in part on the IP fragment's IP fragmentation ID, source address and destination address.

32. The network interface component of claim 28 wherein the IP fragmentation ID is a secondary IP fragmentation ID within an outer IP header of the IP fragment.

33. The network interface component of claim 28 wherein the second circuitry is to enqueue the IP fragment into a queue that is specially instantiated for a flow that is defined at least in part by the IP fragment's IP fragmentation ID.

34. The electronic system of claim 28 wherein the second circuitry is to arrange the IP fragment with another IP fragment in succession in a queue, the IP fragment and the other IP fragment being different fragments of a same larger IP packet.

35. A data center, comprising:
a network that communicatively couples a plurality of electronic systems, the plurality of electronic systems integrated within a plurality of racks, wherein, an electronic system of the plurality of electronic systems comprises a), b), c), d) and e) below:
a) a network interface that is coupled to the network, the network interface comprising a packet processing pipeline, the packet processing pipeline to process packets received from the network;
b) memory to implement a plurality of queues, the plurality of queues to receive the packets after the packets have been processed by the packet processing pipeline;
c) a plurality of processing cores, the plurality of processing cores to receive respective ones of the packets from respective ones of the queues;
d) first circuitry to determine a particular processing core amongst a plurality of processing cores for an IP fragment based at least in part on the IP fragment's IP fragmentation ID; and,
e) second circuitry to enqueue the IP fragment for the particular processing core.

36. The data center of claim 35 wherein the first circuitry is to determine the particular processing core by performing a hash operation for the IP fragment.

37. The data center of claim 35 wherein the IP fragment is an IPV4 or IPv6 IP fragment.

38. The data center of claim 35 wherein the first circuitry is to determine the particular processing core based at least in part on the IP fragment's IP fragmentation ID, source address and destination address.

39. The data center of claim 35 wherein the IP fragmentation ID is a secondary IP fragmentation ID within an outer IP header of the IP fragment.

40. The data center of claim 35 wherein the second circuitry is to enqueue the IP fragment into a queue that is specially instantiated for a flow that is defined at least in part by the IP fragment's IP fragmentation ID.
